(19) United States
(12) Patent Application Publication
(10) Pub. No.: US 2019/0113122 A1
(43) Pub. Date: Apr. 18, 2019

(54) PINION CAGE AND DIFFERENTIAL SYSTEMS HAVING SAME

(71) Applicant: Dana Automotive Systems Group, LLC, Maumee, OH (US)

(72) Inventors: James J. Mehallow, JR., Maumee, OH (US); Ned W. Wright, Maumee, OH (US)

(21) Appl. No.: 16/219,008

(22) Filed: Dec. 13, 2018

Related U.S. Application Data
(60) Provisional application No. 62/740,726, filed on Oct. 3, 2018.

(51) Int. Cl. F16H 48/08

(52) U.S. Cl. CPC F16H 48/08; F16H 2048/087; F16H 2048/085

(57) ABSTRACT

A cage for mounting a set of pinion gears including: at least two support members disposed about a central axis; first and second axially spaced support arms extending circumferentially about the central axis and connecting the first and second support arms to form a cylindrically-shaped cage having an axially extending central passage. The central passage being coaxial with a wheel axle. The first and second arms and the at least two support members define a first window on one side of the cylindrical cage for receiving a pinion gear and a second window on the other side of the cylindrical cage for receiving another pinion gear. The support arms have axially aligned openings positioned at the first and second windows for receiving radially reduced and opposing heads of each of the pinion gears and supporting rotation of the pinion gears. The cage is mounted for rotation about the central axis.

### RELATED APPLICATION

This application claims priority to and benefit of U.S. Provisional Application No. 62/740,726 filed on Oct. 3, 2018 and is hereby incorporated by reference.

### BACKGROUND

The present disclosure relates generally to differential assemblies having planetary gear sets therein. In particular, the pinion gears of the planetary gear set are carried or housed in a pinion cage for compact arrangement. More particularly, a light-weight pinion cage and the arrangement of the cage with the side gears allows compact light-weight enclosure within a gear box. This allows the differential housing to be compact and light weight.

Space and weight are important factors in the design of vehicle components. Weight has a direct impact on fuel consumption and size of the productive load that can be transported. Space needs to be conserved for to allow for all the various components included in modern vehicles, to allow access for maintenance and to permit unused space to be put to more productive uses such as driver and/or passenger comfort and safety considerations.

The present disclosure provides lightweight and compact differential systems having a lightweight and compact pinion cage supporting differential pinion gears. Also disclosed herein are lightweight and compact pinion cage also referred to as a planetary cage for rotationally supporting differential pion gears.

### SUMMARY

A differential system is disclosed having a lightweight and compact gear box and cage. In one embodiment, the differential can include a housing enclosing a pinion shaft rotationally engaged with a ring gear, and a differential case fixedly attached to the ring gear for ration therewith. The gear box having two portions closing around two facing side gears and a pinion cage positioned between the side gears. The side gears can have inner and outer ring gears and the pinion cage can be fixedly connected to an inside surface of the differential case. The pinion cage can have support members circumferentially spaced around a central passage axially which is aligned with the inner ring gears of the side gears. The support members can be connected by axially spaced first and second support arms. The support members and arms define adjacent pairs of slots between each pair of support members that receive and rotationally support pinion gears. Each of the adjacent pair of slots can be positioned such that pinion gears supported there in can have inner portions that intermesh with each other. The inner annular surfaces of the inner ring gears can have gear teeth to engage complimentary gear teeth of a wheel axle. The outer ring gears can have inner annular surfaces that have gear teeth that engage the outer portions of the pinion gears. Rotation of the pinion shaft drives the rotation of the ring gear which rotates the differential case. The cage which is attached to the differential case is also rotated and the pinion gears can transmit the rotation to the side gears to turn the wheel axles and allow differential rotation of the wheel axles.

A pinion cage for compact and light weight rotational support of differential pinion gears is also disclosed. The pinion cage can be fixedly connected to an inside surface of the differential case. The pinion cage can have at least two support members circumferentially spaced around a central passage. The central passage can be axially aligned with the inner ring gears of the side gears. The support members can be connected by axially spaced first and second support arms. The support members and arms define adjacent pairs of slots between each pair of support members. The slots receive and rotationally support pinion gears. Each of the adjacent pair of slots can be positioned such that pinion gears supported therein can have inner portions that intermesh with each other. The inner annular surfaces of the inner ring gears can have gear teeth to engage complimentary gear teeth of a wheel axle. The outer ring gears can have inner annular surfaces that have gear teeth that engage the outer portions of the pinion gears. Rotation of the pinion shaft drives the rotation of the ring gear which rotates the differential case. The cage which is attached to the differential case is also rotated and the pinion gears can transmit the rotation to the side gears to turn the wheel axles. The pinions can also rotate about their own axis to and allow differential rotation of the wheel axles.

### BRIEF DESCRIPTION OF THE DRAWINGS

FIG. 1 shows a cross-sectional view of one embodiment of a differential system according to the present disclosure;

FIG. 2 shows an exploded view of the differential system of FIG. 1; and

FIG. 3 shows a perspective view of one embodiment of a planetary gear cage according to the present disclosure.

### DETAILED DESCRIPTION

It is to be understood that the invention may assume various alternative components, orientations and configurations, except where expressly specified to the contrary. It is also understood that the specific devices and processes illustrated in the attached drawings, and described in the specification are simply exemplary embodiments of the inventive concepts disclosed and defined herein. Therefore, specific dimensions, directions or other physical characteristics relating to the various embodiments disclosed are not to be considered as limiting, unless expressly stated otherwise.

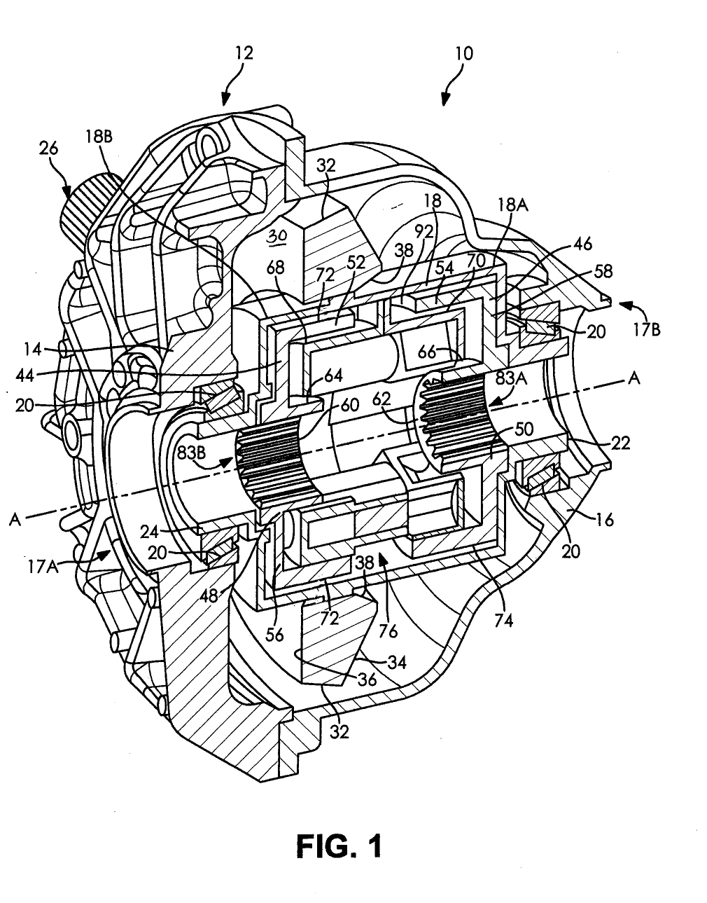

Turning now to FIG. 1, one embodiment of a differential system 10 is depicted. The differential system 10 comprises a differential housing 12. In the depicted embodiment of FIG. 1, the differential housing 12 is a two piece differential housing although the housing can be formed from more than or less than two pieces. The pieces can include a cover portion 14 that can be fastened to carrier portion 16 with mechanical type fasteners and/or welding. Housing 12 includes two opposing coaxial openings 17A, 17B to provide access to wheel shafts. Another opening (not shown) at about 90 degree angle to the wheel axle openings to provide access to a pinion shaft 26. Differential housing 12 is substantially hollow and houses a differential case 18 therein. Housing 12 can be formed of a strong and durable material that has appropriate heat resistance. In one embodiment housing 12 can be formed of a metal or metal alloy such as aluminum or steel. The first and second pieces of the housing 12 can be made of the same material or different materials.

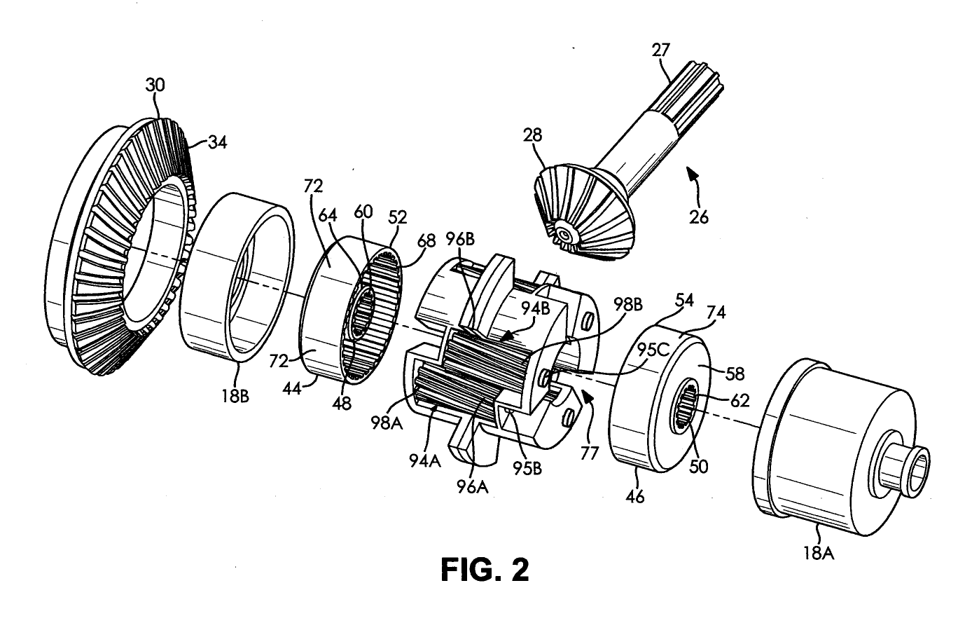

The differential case 18 may be a one-piece case or, as shown in FIG. 2, it may be comprised of two pieces 18A, 18B. The pieces may be substantially equal in size, however, the embodiment in FIG. 2 shows a first piece 18A having a greater axial dimension than a second piece 18B. The axial direction is illustrated by axis “B”. As in the differential housing 12, differential case 18 can be formed of strong durable material such as aluminum or steel. The first and second pieces of the differential housing 18 can be made of the same material or different materials.

The differential case 18 is supported for rotation about Axis “A” within the housing on bearings 20. More particularly, the bearings 20 are located between an outer surface of a first differential case flange 22 and an outer surface of a second differential case flange 24 and an upper and lower inner surface of the differential housing 12.

A pinion gear shaft 26 extends through the differential housing 12. As shown in FIG. 2, the pinion gear shaft 26 has a pinion gear 28 at one end that is contained within the differential housing 12. In the embodiment shown, pinion gear 28 can have a frustroconical shape. The opposite end of the pinion gear shaft 26 extends out of differential housing 12 and includes gear teeth on the outer annular surface 27 at or adjacent a terminal end of the pinion gear shaft 26 for engagement with an input drive shaft or connection to a joint for further connection to a drive shaft.

The pinion gear 28 is meshed or engaged with a ring gear 30. In the embodiment show in FIGS. 1 and 2, ring gear 30 can have a toroidal shape with a relatively flat annular outer wall 32 and two angled side walls 34, 36 that connect to relatively flat inner wall 38. Other types and shapes of ring gear can be used. The angled side wall 34 can have gear teeth to engage with the pinion gear 28. The gear teeth of the pinion gear and the ring gear can be helical type gear teeth. Other types of gear teeth can also be used.

As one embodiment in FIG. 2 shows, inner surface of ring gear 30 is attached to an outer surface of the differential case 18, such as with mechanical fasteners and/or by welding. The differential case 18 can be position within the ring gear 30 and because ring gear 30 is attached fixedly to differential case 18, rotation of ring gear 30 about axis “A” as driven by pinion gear shaft 26 also causes differential case 18 to rotate. As shown in FIG. 1, the ring gear 30 may be located at or adjacent to the intersection of the first differential case piece 18A and the second differential case piece 18B.

A first side gear 44 and a second side gear 46 are located within the differential case 18. First and second side gears 44, 46 can have an inner ring gears 48, 50, respectively radially shaped apart from outer ring gears 52, 54 respectively. Inner ring gears 48, 50 are connected to respective outer rings 52, 54 by a radially extending circular discs 56, 58, respectively. Inner ring gears 48, 50 have an inner annular surfaces 60, 62 and an outer annular surface 64, 66. Inner annular surfaces 60, 62 have gear teeth to engage complimentary gears of first and second axle have shaft, respectively (not shown). In the embodiment shown in FIGS. 1 and 2 the gear teeth can be integrally formed helical or splined type gear teeth. Other gear teeth types can be used.

The outer ring gears 52, 54 also have inner annular surfaces 68, 70 and outer annular surfaces 72, 74. Inner annular surfaces 68, 70 of outer ring gears 52, 54 have gear teeth to engage complimentary gears of planetaries or differential pinion gears described below. In the embodiment shown in FIGS. 1 and 2 the gear teeth can be integrally formed helical or splined type gear teeth. Other gear teeth types can be used.

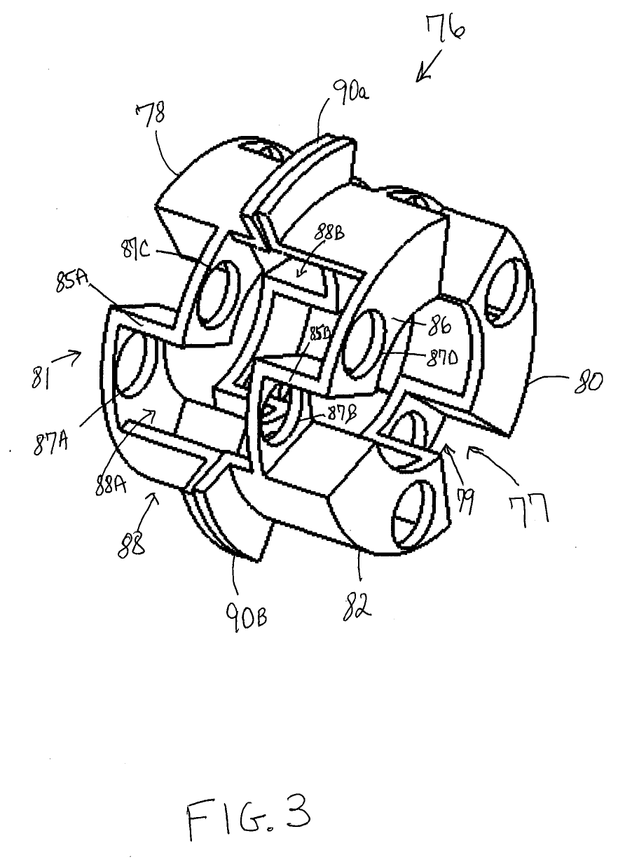

As shown in FIGS. 1 and 2 annular surfaces of outer ring gears 52, 54 have a greater axial extent than inner ring gears 48, 50. This creates a cavity in each of first and second side gear 44, 46. A first axial end and a second axial end of pinion cage 76 are positioned to reside within the side gear cavities. Pinion cage 76 can have passage 77 extending axially through a central portion of planetary gear 76. As shown in FIGS. 2 and 3, pinion cage 76 is positioned such that one axial end 79 of passage 77 is aligned and coaxial with a central opening 83A of inner ring gear 50 of the second side gear 46 and the opposite axial end 81 of passage 77 is aligned and coaxial with central opening of inner ring gear 48 of the first side gear 44. The cage can also have slots that rotationally support or hold the differential pinion gears, which are discussed in more detail below. The pinion cage 76 is positioned so that the slots are located between the axially inwardly extending outer ring gears 52, 54 such that pinion gears are in engagement with the gear teeth on the inner annular surface of the outer ring gears 52, 54 as discussed in more detail below.

Side gears 44, 46 are positioned in facing relation such that the cavities of the side gears 44, 46 are adjacent each other. The axially extending outer rings gears 52, 54 are adjacent each other without touching or making contact. Instead, it is preferred that there is a gap between them. In other words, the axial extent of outer ring gears 52, 54 can be positioned next to each other without contacting each other such that first and second side gears 44, 46 do not fully house or surround pinion cage 76.

In the embodiment shown in FIG. 3, pinion cage 76 can have three support members 78, 80, 82 equally spaced apart circumferentially about central axis “A”. Axially spaced apart first and second support arms 84, 86 connect the three support members 78, 80, 82 to form a cylindrically shaped cage 76 with a passage 77 extending through the center along the central axis “A”. A window 88 is formed between support member 78 and support member 82, and is bounded at axial ends by first and second support arms 84, 86. Two other windows (not shown clearly) are formed between 78, 80 and between 80, 82 that are also bound at axial ends by support arms 84, 86.

At each of the windows and about at a midway point in the circumferential direction, the two support members 84, 86 can be axially offset or have two portion 85A, 85B that extend axially to define or form two or a pair of axially offset slots 88A, 88B, (the other two pairs of slots not shown clearly) within each window.

The three pairs of offset slots (only slots 88A, 88B are shown) can hold three pairs of differential pinions (only pinion gears 94A, 94B are shown in FIG. 2). While three pairs of slots and pinions are depicted, the present disclosure is not limited to three pairs and a greater or fewer number can be used. The pairs of slots support the pairs of pinion gears in contacting relation.

Reference will be made to one pair of pinion gears one pair and slots but it is understood the description applies equally to the other pairs of pinions and slots unless otherwise noted. One pair of differential pinion gears 94 comprises a first differential pinion gear 94A and a second differential pinion gear 94b. First and second differential pinions 94A, 94B each have gear teeth integrally formed on an outer surface and complimentary with the gear teeth of the outer ring gears 52, 54 of first and second side gears 44, 46. The gear teeth can be helical gears as shown in FIGS. 1 and 2, although other gear types can be used.

First and second support arms 84, 86 at the axial ends of each slot can have axially aligned holes. As shown arms 84, 86 have axially aligned holes 87A, 87B at slot 88A, and axially aligned holes 87C, 87D. In the embodiment shown, pinion gears 94A, 94B can each have axially opposed reduced radius heads. The reduced radius heads 95B, 95C of only one side of the pinions 94A, 94B are shown mounted in opening 87B and adjacent opening 87D to allow rotation of the pinion gear about its axis. The other sets of differential pinions are similarly mounted in the cage as described for the first set. In another embodiment, first and second axial pins extending from axial ends of the differential pinion gears are mounted within aligned apertures of the arms.

As discussed above slots 88A, 88B and the associated pinion gears 94A, 94B respectively, can be axially offset such that only adjacent or inner axial ends 96A, 96B of pinion gears 94a, 94b are meshed or engaged with each other. The opposite outer axial ends 98A, 98B can be positioned to mesh or engage with respective one of outer ring gears 52, 54 of the first and second side gears 44, 46 respectively.

In one embodiment, the side gears function as ring gears which the pinions gears can move about. For example, rotation of pinion gear shaft 26 drives ring gear 30 and differential case 18 which is connected to ring gear 18. As pinion cage revolves around axis “A” as driven by connection to differential case 18, pinion gears can engage with first and second side gears 44, 46 and move along with side gears about axis “A” driving the rotation of side gears and respective wheel half-axle. Meshing of gears of each pair of pinion gear prevents rotation of the pinion gears about their own axis and thereby transmit the rotation of the pinion cage to driving the side gears 44, 46. Differential rotation of the wheels are transmitted to the side gears which cause one or both of each pair pinion gear of each pair to rotate about its axis at different rate than the other pinion gear of the pair of pinion gears. In other words, pinion gears can both rotate relative to first and second side gears and also revolve with the first and second side gears about the axis “A” to provide differential rotation of the wheels.

Each support member 78, 80, 82 at or near their axial centers can have fins or tabs 90 that radially extend from an outer surface. Tabs 90A, 90B, 90C can be aligned to pass through gap 92 between the side gears 44, 46 as shown in FIG. 1.

A radial end of each tab or fin 90Aa, 90B, 90C is connected with an inner surface of the differential case 18. The connection may be such as mechanical fasteners and/or welding. The connection fixes the cage 76B with the case 18 so that the two do not rotate with respect to one another. Thus, torque is transferred through the differential case 18, through the cage 76, through the differential pinions and the side gears.

In accordance with the provisions of the patent statutes, the present invention has been described in what is considered to represent its preferred embodiments. However, it understood that this description and the present embodiments shall not be construed in a limiting sense and that the invention can be practiced otherwise than as specifically illustrated and described without departing from the true spirit and scope of the invention which is defined by the following claims. Furthermore, it will be appreciated that any changes and modifications would be recognized by those skilled in the art as an equivalent to one or more elements recited in the following claims, and shall be covered by such claims to the fullest extent permitted by law.

1. A cage for mounting a set of pinion gears of a differential system comprising:
at least two support members circumferentially disposed about a central axis; and
first and second axially spaced apart support arms extending circumferentially about the central axis and connecting the first and second support arms to form a cylindrically-shaped cage having an axially extending central passage, the central passage being coaxial with a wheel axle of the differential,
wherein the first and second arms and the at least two support members define a first window on one side of the cylindrical cage for receiving a pinion gear and a second window on the other side of the cylindrical cage for receiving another pinion gear,
wherein the first and second support arms having axially aligned openings positioned at the first and second windows for receiving radially reduced and opposing heads of each of the pinion gears and supporting rotation of the pinion gears, and
wherein the cage is mounted for rotation about the central axis in the differential.

2. The cage of claim 1 further comprising a third support member spaced equidistantly from the at least two support members about the central axis and connected to the at least two support members by the first and second axially spaced apart support arms, wherein the three support members and axially spaced apart support arms define a third window and the first and second support arms having aligned openings positioned at the third window for receiving radially reduced and opposing heads of a third pinion gear.

3. The cage of claim 2, wherein the circumferentially extending first and second support arms are axially offset at a central portion of each of the windows to define a pair of axially offset slots, each slot bounded at axial ends by aligned holes for receiving the radially reduced heads of pinion gears.

4. The cage of claim 3, wherein each of the support members have a radially extending tab for attachment to a differential case for rotating with the differential case.

5. The cage of claim 4, wherein each of the pairs of slots are circumferential spaced such that an axial end section of a first pinion gear received in one of the slots of the pair of slots meshes with an axial end section of second pinion gear received in the other one of the slots of the pair of slots, and the opposite axial end section of the first pinion gear is exposed to engage a first side ring gear of a differential system and the opposite end section of the second pion gears is exposed to engage a second side ring gear of the differential system.

6. A differential system comprising:
a pinion shaft rotatably connected to a main ring gear;
a differential case connected to and surrounded by the main ring gear for rotation therewith, the differential case housing a gear set;
wherein the gear set includes a first side gear and a second side gear, each side gear having an inner ring gear for rotationally engaging a wheel half-axle and an outer ring gear having gear teeth on an inner annular surface, the inner and outer ring gears connected by a radially extending disk member, the outer ring gear having a greater axial extent than the inner ring gear and defining a cavity bound by the cap and outer ring gear; and
a pinion cage rotationally supporting a plurality of pinion gears, the pinion cage fixedly attached to a gear box for rotation therewith, one axial end of the pinion cage positioned within a cavity of the first side gear and an opposite axial end of the planetary gear positioned within a cavity of the second side gear.

7. The differential system of claim 6, wherein the pinion cage rotationally supports three pairs of pinion gears circumferentially spaced equidistantly about the pinion cage; one of the pinion gears of each pair of pinion gears being axially offset relative to the other of the pinion gears of each pair of pinion gears such that an outer axial end of one of the pair of pinion gears engages with the outer ring gear of the first side gear and an outer axial end of the other pinion gear engages with the outer ring gear of the second side gear, and the inner ends of each pinion gear of each of the pair of pinion gears intermeshed with each other.

8. The differential system of claim 7, wherein the differential case is formed of a differential case portion connected to a differential case cap.

9. The differential system of claim 7, wherein the pinion cage has first and second axially spaced apart support arms extending circumferentially about a central axis and connecting three support members equally spaced apart to form a cylindrical-shaped cage having a central passage; the first and second arms and the three support members defining three windows, each window positioned between each pair of the three support members for supporting at least one pinion gear.

10. The differential system of claim 9, wherein the first and second support arms at a central of each of the three windows has two axially extending offset portions defining two adjacent and offset slots, each slot rotatably supporting a pinion gear.

11. The differential system of claim 10, wherein the first and second arms at each offset slot have axially aligned openings of receiving radially reduced and opposing heads of the pinion gears.

12. The differential system of claim 9, wherein each of the three support members have a radially extending tab for attachment to the differential case for rotating with the differential case.

13. The differential system of claim 10, wherein each of the two adjacent and offset slots are circumferential spaced such that an axial end section of a first pinion gear received in one of the slots of the two adjacent offset slots meshes with an axial end section of second pinion gear received in the other one of the two adjacent offset slots, and the opposite axial end section of the first pinion gear is exposed to engage a first side ring gear and the opposite end section of the second pion gears is exposed to engage a second side ring gear.
